(19) United States
(12) Patent Application Publication
(10) Pub. No.: US 2002/0143620 A1
(43) Pub. Date: Oct. 3, 2002

(54) Device and method for capturing data from attendees during events

(76) Inventor: Matthew D. Kraus, Stamford, CT (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 09/822,163

(22) Filed: Mar. 30, 2001

(51) Int. Cl. G06F 17/60

(52) U.S. Cl. 705/14

(57) ABSTRACT

A data collection device is used for collecting contact and demographic data. The device has a unique identifier, which is used to track the collected data. A first computer system is used to create a database of searchable information including the demographic data linked to the unique identifier, collected using the collection device. A second computer system is connected to the first computer system. The second computer system displays information received from the first computer system in response to queries transmitted from the second computer to the first computer.

### FIELD OF THE INVENTION

The present invention relates to methods and systems collecting data. More specifically, the invention relates to collecting and disseminating data collected from event attendees.

### BACKGROUND OF THE INVENTION

During trade shows, conventions, and the like, there exists a need to collect as much information about the attendees as possible. Event sponsors attract vendors and exhibitors to events by providing data regarding event attendees and having a system in place to gather data during the event. Typically, minimum contact information is collected from a large number on event attendees. One method and device used for data collection is an identification badge, which is designed to give a method for recording, qualifying, and acting on sales leads generated at a trade show, conventions, and the like. The identification badge includes a 2-dimension bar code, which encodes an attendees name and contact information. The Trade Show Exhibitors Association has standardized data file formats for exhibitors' data collection in its standard, TSEA/HCEA01. The standard has 41 mandatory fields, demographic information, and qualifier information. The data fields include badge ID, attendee name, title, company, address, phone number, facsimile number, and email. Additionally, other demographic data can be coded into the badge.

The system, which resides with each exhibitor at a trade show, scans the attendee's badge and gives the exhibitor a printed description and database record for that attendee. Each record can be annotated with the custom qualifiers to assist in lead qualification and post event follow-up. At the end of a trade show, each exhibitor has a list of attendees that visited their display and allowed their badge to be scanned. If the exhibitor was busy or the attendee did not have the badge scanned, valuable leads are lost. Additionally, there is no sharing of collected data, the only information an exhibitor has is the data that each specific exhibitor collected. What is needed is a method and device that insures maximum data capture and dissemination, which unobtrusively tracks attendee' actions. The data that is collected is then shared amongst the various event participants.

### BRIEF SUMMARY OF THE INVENTION

These and other limitations of the prior art are addressed in the present invention, which provides a system for collecting market data. A data collection device is used for collecting contact and demographic data. The device has a unique identifier, which is used to track the collected data. A first computer system having a processor, and a memory for storing instructions executable by said processor, is used to create a database of searchable information including the demographic data linked to the unique identifier, collected using the collection device. A second computer system, having a processor and a memory for storing instructions executable by the processor, is connected to the first computer system. The second computer system displays information received from the first computer system in response to queries transmitted from the second computer to the first computer.

### BRIEF DESCRIPTION OF THE DRAWINGS

FIG. 1 is a representation of a data collection device according to the present invention;

FIG. 2 is a flowchart illustrating a process for collecting and utilizing marketing data; and

FIG. 3 is a block diagram of one environment of the present invention.

### DETAILED DESCRIPTION OF THE INVENTION

During trade shows, conventions, live sporting events, and the like, vendors and exhibitors strive to capture as much data regarding attendees as possible and to have those attendees exposed to as much advertising copy as possible. Additionally, the event sponsor seeks to collect data for future event promotion and to sell attendee data to other interested parties. The present invention relates to a turnkey system that provides a comprehensive list of event attendees and valuable data regarding those attendees while providing the attendees with in-hand advertising copy. The present invention provides a system with minimal clutter to ease the collection of data, which is used to generate sales, potential sources of sales, and revenue. The disclosed system has at least three components for creating an effective marketing program including, on-site attendee data collection, continuous access to the collected data, and post event intelligence.

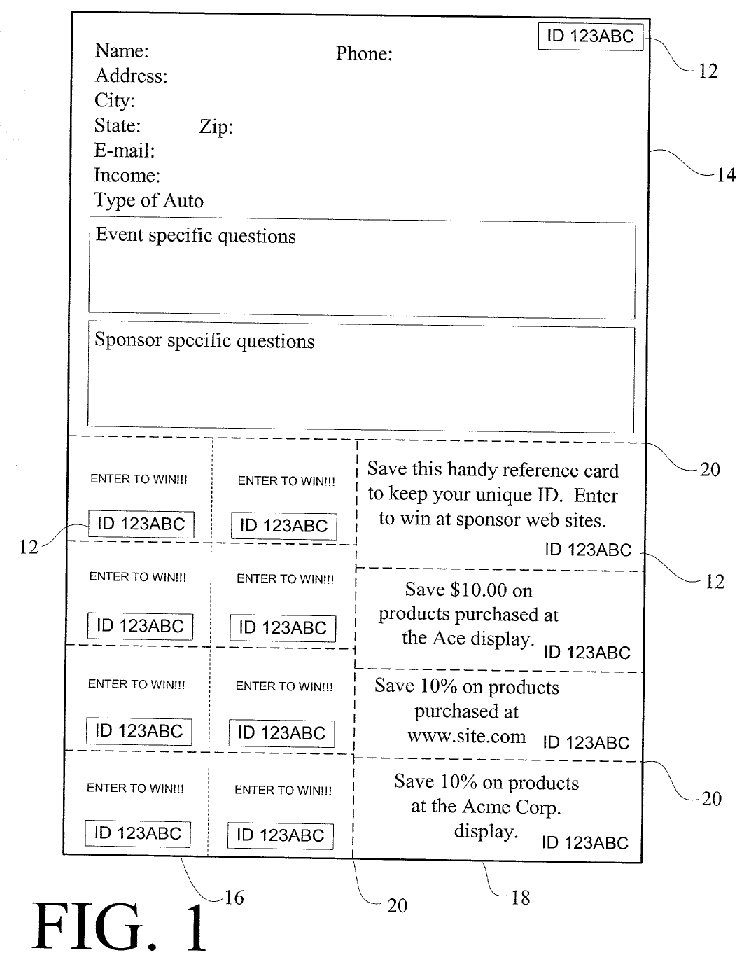

FIG. 1 is a representation of a data collection device according to the present invention. The data collection device is fully customizable. The first side of data collection device 10 is preferably divided into three sections. A first section 14 contains a sweepstake overlay. A second portion 16 of the data collection device 10 contains contest or sweepstakes entry coupons for use during the event. The third portion 18 of the data collection device 10 includes coupons for use both during and after the event. The sections of data collection device 10 are detachable. In one embodiment, perforations 20 separate the various sections. The second side of collection device 10 contains advertising copy. The advertising copy includes slogans, logos, and the like.

The sweepstake overlay 14 is used to collect information about the attendee including name, address, email, telephone number, facsimile number, and the like. Additionally, in one embodiment, event specific data is collected, such as during a golf match, handicap, rounds of golf played per year, type of balls or clubs used, type of course played, and the like. Other questions seek attendee income, interest in other products, and the like. In one embodiment of the invention, additional information regarding specific products or services can be requested. The sweepstake overlay has a unique identifier 12, which is used to match collected data regarding to each specific attendee. The unique identifier is an alphanumeric code, one-dimensional bar code, two-dimensional barcode, or the like.

A second portion 16 of the data collection device 10 contains sweepstakes or contest entries. In one embodiment, the entries are for specific vendors or exhibitors. These sweepstakes or contest entries are coded with the same unique identifier 12 as the sweepstakes overlay. These sweepstake or contest entries are deposited in entry boxes located at vendor or exhibitor booths. The vendors or exhibitors follow-up with each attendee that made an entry as a lead to potential business. Additionally, the entries each attendee makes are used to create a demographic picture of that attendee's interests.

The third portion 18 of the data collection device 10 contains money saving coupons or the like. These coupons are encoded with the same unique identifier 12 as the sweepstakes overlay. The coupons are for specific products or services available during or after the event. In one embodiment of the invention, the attendee enters the unique identifier on an Internet web page to enter additional contests and receive information regarding specific products. In one embodiment, the URL for the Internet web page is printed on the coupon. These visits to Internet sites are also recorded in the data collection database.

The collected data is entered into a database. The database contains the data collected from the attendees on the sweepstakes overlays, as well as all of the vendors or exhibits the attendees visited. Additionally, the database contains information concerning which coupons the attendees used and which websites the attendees visited. Throughout the event, the data that is collected is entered into the database. In this manner, the database is kept current. In one embodiment, the sponsor, the exhibitors, and vendors have ongoing access to the data via the Internet. Each sponsor, vendor, or exhibitor would sign onto website, preferably using a unique username and password combination. In one embodiment of the invention, a users are given varying access to the database. The ability to retrieve information from the database is determined by the username and password combination. Once access is granted, the user is able to query the database to get focused lead results and attendee information. The data is stored on a secure server, which users are able to query, but preferably, not modify. In one embodiment of the invention, the query results are delivered to the user using dynamically generated HTML or a dynamic mark-up language, such as LDML (Lasso Dynamic Mark-Up Language), which creates a reporting window on the user's system.

The database is a comprehensive collection of the data regarding attendees to an event. The database includes sponsor specific data as well as general attendee interest in specific areas. The database provides opportunities for custom analysis, targeted direct marketing, list rental, or sales revenue. In one embodiment of the invention, the event organizer, in conjunction with the vendors or exhibitors, prepares the data collection device. In this manner, specific information regarding event attendees is available to the sponsor and the individual vendors or exhibitors. This enhances a vendor's or exhibitor's interests in an event due to the marketing data each vendor or exhibitor receives.

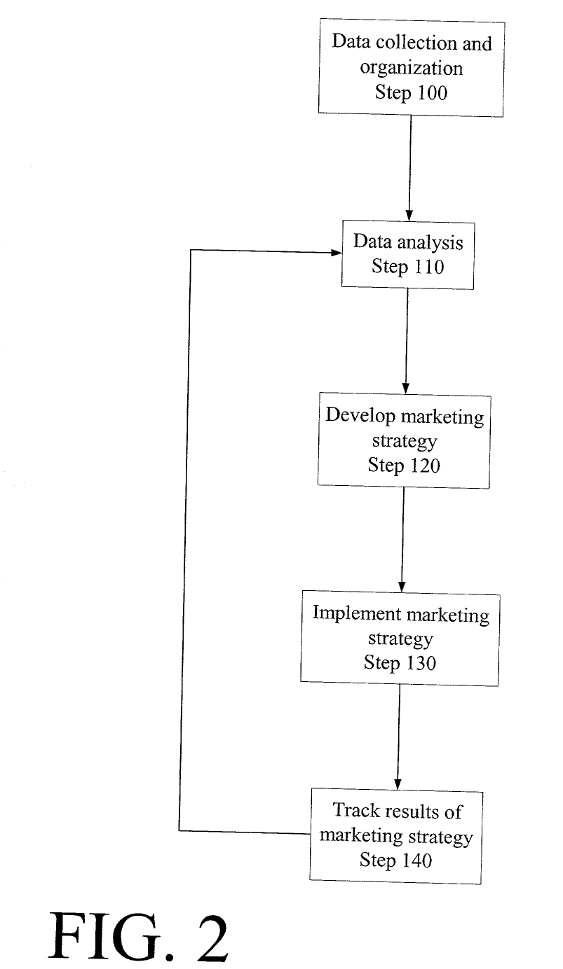

FIG. 2 is a flow chart illustrating a process for collecting and utilizing marketing data. Initially, the data is collected and organized (Step 100). Database organization includes refining said database according to a set of filters. Data is collected from various sources such as exhibitor databases, website visits, event ticket buyers, sweepstakes entrants, local business sponsors, sponsor lists, business cards, hospitality booth visitors, internet site registrants, contest entries, telephone calls and the like. The sponsor, vendors, exhibitors, third party service providers, or the like enter the data. This data is entered into a database and organized. Once the data is entered into the database, duplicate entries are removed and existing files are updated. Traditionally, in one embodiment, the data is organized to minimize postal costs and direct mailings.

In one embodiment, fictitious data entries are placed in the database to track unauthorized data base use. Once the database has been purged of duplicate and incorrect entries it is in a condition to provide responses to queries. Specific queries are used to identify specific target groups, which can be used for direct marketing the content of the database is analyzed to determine an appropriate marketing strategy (Step 110). In one embodiment, users would access the database via a secure website. Once the user is aware of the content of the database, a marketing strategy can be decided upon and implemented (Step 120). The marketing strategy includes concept development, graphic design, mechanical production, printing, and project management. Implementation of a marketing plan includes direct mail, e-mail, and e-commercials (Step 130). Responses and results from the marketing campaign are monitored (Step 140) and these results are used to update the database.

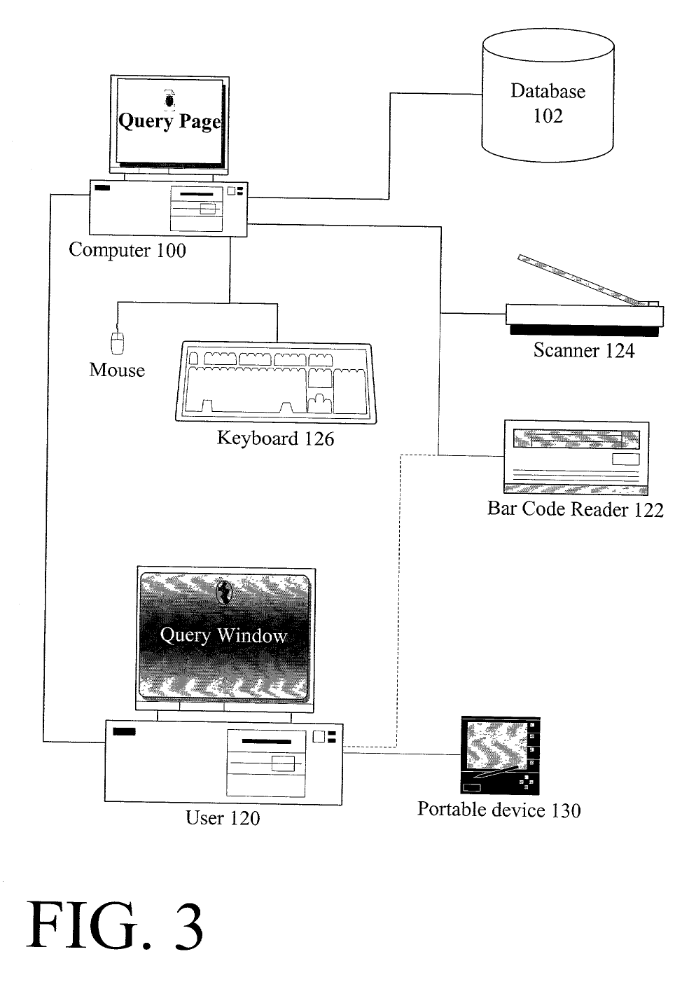

FIG. 3 is a block diagram of one environment of the present invention. Computer 100 is used to update and maintain the database 102. Additionally bar code reader 122, scanner 124, and keyboard 126 are used to enter data into database 102. These imputed devices may be remotely located at a vendor or exhibitors booth, web site, business, or the like. Further, events logged at a vendor's website are input into the database 102. A user 120 accesses the database 102 via a secure internet site, modem, or the like. The user has access to query the database, not modify the data stored in the database. Once user 120 accesses database 102, queries can be made of the database to provide user 120 with specific target marketing information. Query results can be downloaded to a handheld computer 130 either directly from the database or from user 120. In one embodiment of the invention, event attendee is provided on recordable compact disks or the like.

The disclosed data collection device is convenient to use. The tear-off sweepstakes and contest entries and coupons are easier to use than an I.D. badge having a bar code or other identifier. The tear-off entry forms and coupons can be input into the database later using scanners or bar code readers. When vendors or exhibitors are busy, it is difficult for every attendee to be dealt with on an individual basis. Therefore, the vendor or exhibitor does not capture many attendees' information. Using sweepstakes contests, or coupons, information about the attendees is collected by vendors, exhibitors or sponsors when attendees leave a coupon with the unique identifier without being taken cared of by a person at a vendor's or exhibitor's booth.

The event sponsor has access to the entire database. Each of the vendors or exhibitors would also have access to the database. In one embodiment, access is granted to the database for a fee. Finally, other parties are able to run specific queries in the database on a per name or per query cost. In one embodiment of the invention, access to the database is determined by the amount of advertising purchased. For example, an exhibitor or vendor that purchases at least one contest or sweepstakes entry coupons (16, FIG. 1) would have access to data collected regarding the purchased contest or sweepstakes entry coupons, whereas an event sponsor that purchases advertising copy on the second side of the collection device would have greater access to the collected data.

Although the present invention was discussed in terms of certain preferred embodiments, the description is not limited to such embodiments. Rather, the invention includes other embodiments including those apparent to a person of ordinary skill in the art. Thus, the scope of the invention should not be limited by the preceding description but should be ascertained by reference to the claims that follow.

What is claimed is:

1. A device for collecting data associated with a user comprising:
a first and second side, said first side having a first area containing an identifier uniquely associated with said device and a plurality of preprinted questions including an area for data entry by said user, said questions eliciting said data associated with said user;
a second area containing at least one preprinted coupon, said at least one coupon containing said unique identifier; and
said first area and said second area are physically detachable.

2. The device of claim 1 wherein the unique identifier is a series of alphanumeric characters.

3. The device of claim 1 wherein the unique identifier is a barcode.

4. The device of claim 1 wherein the first area contains survey questions.

5. The device of claim 4 wherein the first area is a contest entry form.

6. The device of claim 1 wherein said coupon contains product discounts.

7. The device of claim 1 wherein said coupon contains a URL.

8. The device of claim 1 wherein said second side of said device contains advertising copy.

9. A system for collecting market data, said system comprising:
a data collection device having a first and a second side, said first side having a plurality of preprinted questions for collecting demographic data, said device having a unique identifier, said demographic data including name and contact information, said second side having advertising copy;
a first computer system including: a processor, a memory for storing instructions executable by said processor, and at least one database of searchable information, said searchable information including said demographic data linked to said unique identifier; and
a second computer system connected to said first computer system, said second computer system including a processor, a memory for storing instructions executable by said processor, and a display device for displaying information received from said first computer system.

10. The system of claim 9 wherein said second computer system is connected to said first computer system via the Internet.

11. In a computer network comprising a plurality of computers capable of exchanging digital information, at least one of said plurality of computers being associated with at least one information provider and at least one of said plurality of computers being associated with a user seeking said information, said one of said plurality of computers being associated with a user having a display device for displaying information received from said information provider, said at least one of said plurality of computers being associated with at least one information provider, a computer implemented method to navigate and search said database of searchable demographic data comprising:
establishing a database of searchable records comprising demographic data, said demographic data being collected with a device having a unique identifier and at least one data field, said database being associated with at least one information provider;
establishing a link between said information provider's computer and said user's computer;
displaying on said user's display an interface for querying said database;
receiving a query from said user;
creating a separate workspace on said user's computer; and
providing to said user said records corresponding to said query in said separate workspace.

12. The method of claim 11 wherein said interface is a web page having at least one hyperlink.

13. The method of claim 11 wherein said separate workspace is created using dynamically generated HTML.

14. The method of claim 11 wherein said separate workspace is created using a dynamic mark-up language.

15. The method of claim 11 wherein at least one of said records corresponding to said query is fictitious.

16. A method of direct marketing comprising the steps of:
distributing a device for collecting demographic data, said device having a unique identifier and comprising at least a first portion and a second portion, said first portion being used to collect at least a patron's name and associate said name with said unique identifier, said second portion having at least one coupon, said coupon containing said unique identifier, said coupon being used to collect additional information regarding said patron;
creating a database, said database comprising said demographic data for potential customers;
updating said database with said additional information;
refining said database according to a set of filters, said filters organizing said demographic data to remove duplicates;
receiving a query, said query sorting said data in said database;
creating and implementing a tactical data marketing initiative;
deploying said tactical data marketing initiative;
capturing event data, said event data; and
monitoring said event data to create and modify future tactical data marketing initiatives.

17. The method of claim 16 wherein the filters organize said demographic data to minimize postal costs.

18. The method of claim 16 wherein said tactical data marketing initiative comprises concept development, graphic design, mechanical production, printing, and project management.

19. The method of claim 16 wherein said tactical data marketing initiative is deployed in a manner to minimize cost.

20. The method of claim 16 wherein said demographic data for potential customers is collected using a device for collecting data comprising:
a first area containing a unique identifier and preprinted questions, said questions for eliciting said data and a second area having preprinted coupons, said coupons for entering contests, said coupons having said unique identifier.

21. A system for collecting market data, said system comprising:
means for collecting data, said data including demographic data, said demographic data associated with a unique identifier, said demographic data including name and contact information;
means for providing a database of searchable information, said searchable information including said demographic data linked to said unique identifier; and
means for searching said database of searchable information;
wherein said means for providing a database of searchable information is linked to said means for searching said database of searchable information.
